(19) United States
(12) Patent Application Publication
(10) Pub. No.: US 2022/0272305 A1
(43) Pub. Date: Aug. 25, 2022

(54) System for Detection and Video Sharing of Sports Highlights

(71) Applicant: Santiago Rivera-Placeres, Miguel Hidalgo (MX)

(72) Inventor: Santiago Rivera-Placeres, Miguel Hidalgo (MX)

(21) Appl. No.: 17/674,047

(22) Filed: Feb. 17, 2022

Related U.S. Application Data
(60) Provisional application No. 63/153,260, filed on Feb. 24, 2021.

(51) Int. Cl. H04N 7/18

(52) U.S. Cl. CPC H04N 7/188; H04N 7/181

(57) ABSTRACT

An automatic system for detecting goals, trimming a portion of the video where they occur, and sending it to players and related persons' electronic devices. The system can send goals and notable moments of matches or practice. It can operate on soccer, hockey, and other type of sports. The system works by itself without the help of any human intervention once in operation.

### CROSS-REFERENCED TO RELATED APPLICATIONS

This application is a non-provisional application of Application No. 63/153,260, filed Feb. 24, 2021, and claims priority from that application which is also deemed incorporated by reference in its entirety in this application.

### STATEMENT REGARDING FEDERALLY SPONSORED RESEARCH OR DEVELOPMENT

Not applicable

### BACKGROUND OF THE INVENTION

Parents, relatives, and friends would like to share the joy of a player scoring a goal in sports, such as soccer, however on many occasions they cannot be there. Players would also like to watch those moments by themselves and share them. Obtaining and editing a quality video would require either to have someone, usually a parent or coach, capturing videos on their mobile phones or to have a fixed camera, and then going through those recorded videos editing, tagging, and sending video segments. This results in many unrecorded goals, many recorded with bad quality, or with goals in the middle of a long video where it is hard to find them. Thus, most videos are not seen by players, nor shared with friends and family.

Thus, there is a real need for a system and method for automated video processing of events. More specifically, there is a need for systems and methods that provide automatic detection of highlights occurring at an event and the automated creation and distribution of video clips of such highlights employing an updated database with contact information allowing the system to communicate with players or for others wanting to receive such video clips. Likewise, there is a need for a system that allows zoomed images, virtual images, text, and sound to be added to the video clips.

The need for such systems and methods is not restricted to professionals in the sports and entertainment business. Nonprofessional participants, including children and other individuals who play for fun or health with their friends or neighbors, can benefit by personally receiving video clips of their games' highlights. Ideally, these video clips will be sent automatically and made available in an accessible format allowing the recipients to easily share or show their video clips to other after the match, game or other event, for their entertainment, analysis or other purposes.

There is also a need to a system that enables sports league and other event managers, and other parties involved with an event, to obtain and maintain current contact information from all participants and to send such participants information related to future events and other materials of potential interest. This is different than prior art data collection systems. Normally prior art data collection systems only gathered contact information for only one or two people per team, and this often soon became outdated.

### SUMMARY OF THE INVENTION

The present disclosure is directed to a system and method for capturing videos of events and is described in the context of the sport of soccer, although the present invention has much broader application. One feature of the present invention is that it is able to create video recordings of soccer matches or soccer practices, detect goals and other highlights, create video clips comprising a segment of the video recordings covering the period of time when the goal or other highlight occurred, and sending the video clips of the goals and other highlights to players and other interested persons.

The system may be executable by a processor, by cameras having processing capabilities, or in the cloud.

The system includes receiving, by a processor, an input video stream of a soccer match or practice.

The system includes determining, by a processor, a goal or a notable moment within the input video stream, by training artificial intelligence to detect the probability of a soccer ball within a specified area.

The system also generates, by the processor, a video clip including the goal, a portion of the input video stream preceding the determined notable moment, and a portion of the input video stream following the determined notable moment.

The system may additionally include outputting, by the processor, the video clip and sending it electronically to players and related persons.

The system also allows for players and related persons to edit the video clip with actions such as zooming into parts, adding text, adding sound, and adding images.

In various embodiments, the system of the present invention comprises a processor coupled to a plurality of highlight detection cameras, each pointed toward and focused on a separate portion of a playing venue, and at a plurality of video capture cameras each pointed toward and focused on a separate portion of a playing venue. The system of such embodiments further comprises a first database adapted to contain identification and related delivery information, and a second database adapted to contain separate video streams captured by the plurality of video capture cameras. The system also includes a sensor adapted to transmit signals indicative of the actual beginning of an event. All the foregoing elements are coupled to a processor which may be located on site or hosted in the cloud. The processor is adapted to receive a signal indicative of the actual beginning of an event from the sensor and to respond to that signal indicative of the actual beginning of an event by (i) actuating said plurality of video capture cameras and storing in the second database a separate video stream transmitted by each of the plurality of video capture cameras, (ii) actuating the plurality of highlight detection cameras, monitoring separate video feeds generated by each of the highlight detection cameras, and identifying a change in any of said separate video feeds indicative of a highlight, (iii) selecting at least one of the plurality of video streams in response to changes in the video feed indicative of a highlight, (iv) creating a video clip from the selected video stream(s), and (v) transmitting the video clip based on identification and delivery information contained in the first database.

The system will include at least one user interface for entering the data used to populate the first database. The user interface can include a video monitor and keyboard. Alternatively, the user interface can include a scanner adapted to scan codes containing identification and delivery information and populate the first database with identification and delivery information contained in said scanned codes. Such codes could, for example, be bar codes, or QR codes. The identification information stored in the first database will typically include information identifying a player, a player's team, and an electronic address related to the player. The electronic address could be an e-mail address, a cell phone number used for text messaging, an address used by a social media or specialty application, or the like. The first database may also include additional information about the player such as the player's uniform number, age, full name, school, or physical address. This database may also include a list of player specific contacts and electronic addresses for such contacts. Such player specific contacts could include a player's parents, grandparents, uncles, aunts, siblings, and other family relations. Such player specific contacts can also include a player's friends, coaches, teammates, and anyone else with whom the player would like to share video clips generated by the systems and send to the player's contacts.

The sensor adapted to transmit signals indicative of the actual beginning of an event is typically coupled to a scoreboard located at a venue where the event is taking place. In some embodiments, this sensor is a camera pointed toward and focused on a clock on a scoreboard located at a venue where the event is taking place. The processor will monitor the feed from this camera and turn the highlight detection cameras and video feed cameras on and off as the game clock on the scoreboard is turned on and off.

Each highlight detection camera is pointed toward and focused on a portion of the event venue where a highlight will typically occur. In venues hosting games such as soccer, hockey, and basketball, this is typically the portions of the venue in and around the goals but may be expanded so that additional highlight detection cameras are pointed toward and focused on other portion of a playing surface where highlights often occur. No matter the number of highlight detection cameras, the processor is adapted to actuate each of said plurality of highlight detection cameras and monitoring video feed from each of said highlight detection cameras for changes in any of said video feeds indicative of a highlight.

The system may also employ a plurality of video capture cameras pointed toward and focused on different portions of a playing surface. The processor is adapted to actuate each of the video capture cameras and store in the second database separate video streams generated by each of the plurality of video capture cameras.

When the processor detects a change in the video feed from one of the highlight detection cameras indicative of a highlight, the processor select at least one video stream from the separate video streams generated by the video capture cameras based on which feed is changed and when. The selected portion of the video stream(s) is of a predetermined duration commencing a first predetermined period of time before and ending a second predetermined period of time after a change in the video feed indicative of a highlight. The processor then creates from said selected separate video stream(s) a video clip. Once created, the processor transmits the video clip based on identification and delivery information contained in the first database.

The processor in certain embodiments is also capable of enhancing the clips in various ways prior to transmitting them to the players involved in the highlight and other related recipients. For example, music, text, and graphics may be added to the clip automatically. Likewise, multiple clips may be assembled as a package automatically with transitions between the clips and text, graphics and sound added to the package.

Likewise, access codes and associated time stamps may be transmitted with or separately from the clips allowing users to access the video feed and create their own clips and highlight packages separate from those created automatically by the system.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a schematic isometric view of a soccer field equipped with an exemplary embodiment of the present invention.

FIG. 2 is a schematic top view of a soccer field, focusing attention on the Video Capture Cameras of the exemplary embodiment of FIG. 1, and the area of the soccer field which each cover.

FIG. 3 is a schematic top view of a soccer field, focusing attention on the Detection Cameras of the exemplary embodiment of FIG. 1, and the area of the soccer field which each cover.

FIG. 4 is a photograph of Video Capture Camera of the exemplary embodiment of FIG. 1 from which videos are filmed.

FIG. 5. is a photograph of a Video Detection Camera of the exemplary embodiment of FIG. 1 from which videos are analyzed to determine if a ball is detected in or around a soccer goal.

FIG. 6 is a photograph of a light sensor of the exemplary embodiment of FIG. 1 directed towards a LED on the game clock of a Scoreboard used to detect when the game clock starts and stops.

FIG. 7 is a screenshot of a schedule of matches in a day for the venue of the exemplary embodiment of FIG. 1.

FIG. 8 shows an exemplary identification card with a QR code containing identification and contact information that may be used to populate a database employed by the exemplary embodiment of FIG. 1.

FIG. 9 is a flowchart of Fast QR showing how the identification card of FIG. 8 may be used with a smart phone or tablet phone to access and add data to a database employed by the exemplary embodiment of FIG. 1.

FIG. 10 is a screenshot of the polygon which limits the area where Ball Detection is analyzed by the exemplary embodiment of FIG. 1.

FIG. 11 is a screenshot of ball detection training by an artificial intelligence of the exemplary embodiment of FIG. 1 showing the probability assigned by the algorithm that it is a ball.

FIG. 12 is a screenshot of the polygon which limits the area for ball detection by the exemplary embodiment of FIG. 1, in which only movement in it is analyzed, and in this case viewed in color.

FIG. 13 is a screenshot of players in the monitor of the processor of the exemplary embodiment of FIG. 1.

FIG. 14 is an image of a mobile phone displaying a video clip created and transmitted by the exemplary embodiment of FIG. 1 of a goal scored during a soccer match.

FIG. 15 is a schematic diagram showing the portions of a soccer field where action can trigger the system of the exemplary embodiment of FIG. 1 to generate video clips.

FIG. 16 is a screenshot of a feature of a smart phone application used in conjunction with the exemplary embodiment of FIG. 1 allowing users to zoom into parts of the video.

FIG. 17 is screenshot of example text that can be added to a video clip by the exemplary embodiment of FIG. 1.

FIG. 18 is a screenshot of example graphics that can be added to a video clip by the exemplary embodiment of FIG. 1.

FIG. 19 is a flow chart depicting process steps employed by the exemplary embodiment of FIG. 1.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

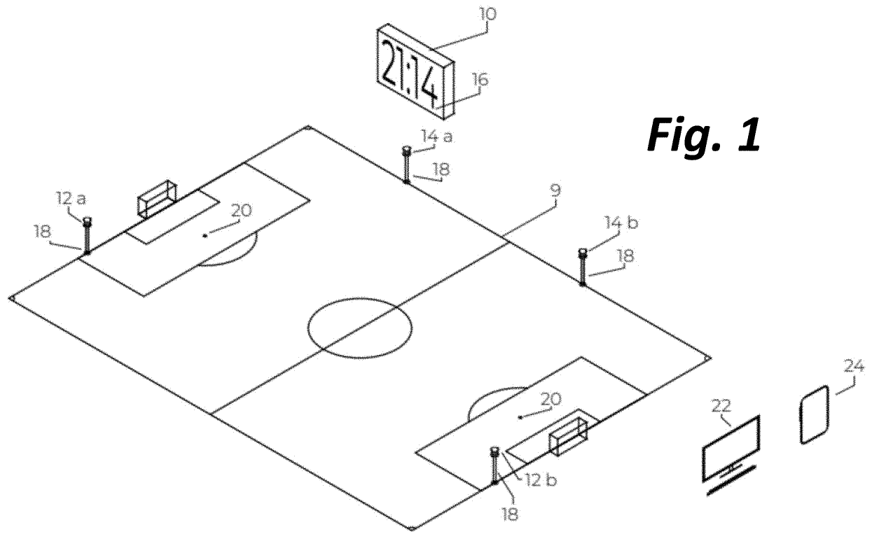

FIG. 1 provides a simplified schematic view of all the elements required to run the system in a Soccer venue 9. The system is essentially comprised of two cameras that film video that will be used for detection (Detection Cameras 12a and 12b), two cameras that film video that will be used to capture a nice angle to be sent to users (Video Capture Cameras 14a and 14b), a Computer 22 (to process the data using artificial intelligence algorithms), a Scoreboard 10, and a Sensor 16 to help determine that a match is occurring when goals are detected. The system can also includes a user terminal/interface 24 which includes a keyboard, display and scanner for face identification or scanning codes such as a QR code or bar code. The user interface terminal 24 may be in the form of a smart phone or tablet computer.

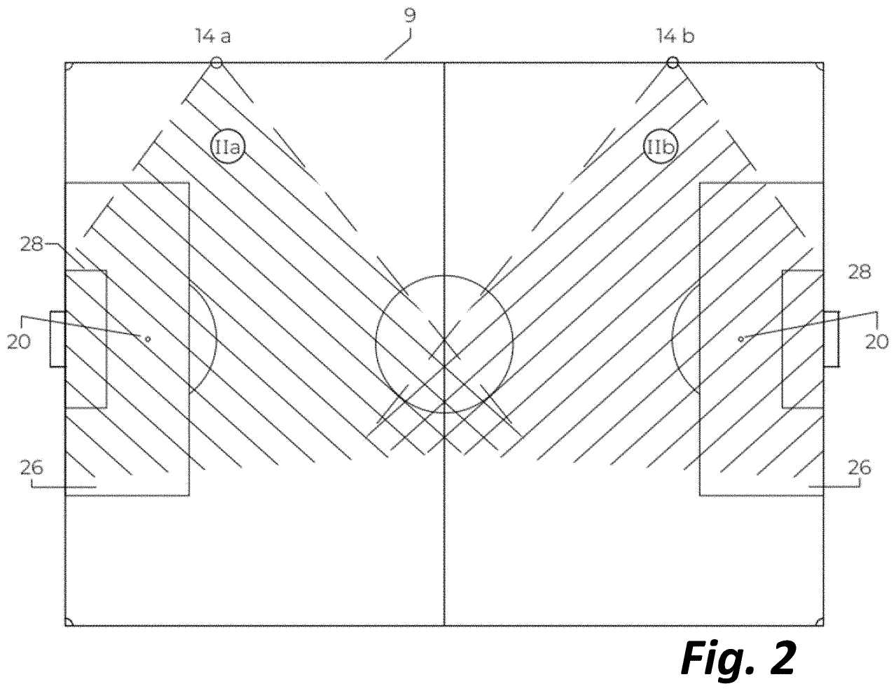

FIG. 2 shows both Video Capture Cameras 14a and 14b which, as their name implies, film (capture) videos of the sporting event from a viewpoint to show the highlights in an engaging/outstanding way. The videos filmed with these cameras are temporarily stored on Computer 22 or in the cloud. The sections where those cameras aim are depicted as Video Recording Areas IIa and IIb. These areas cover most places where the event's highlights happen, for example Penalty Spot 20, Goal Boxes 28, most of Penalty Box 26 and most of the central part of the Soccer Field 9.

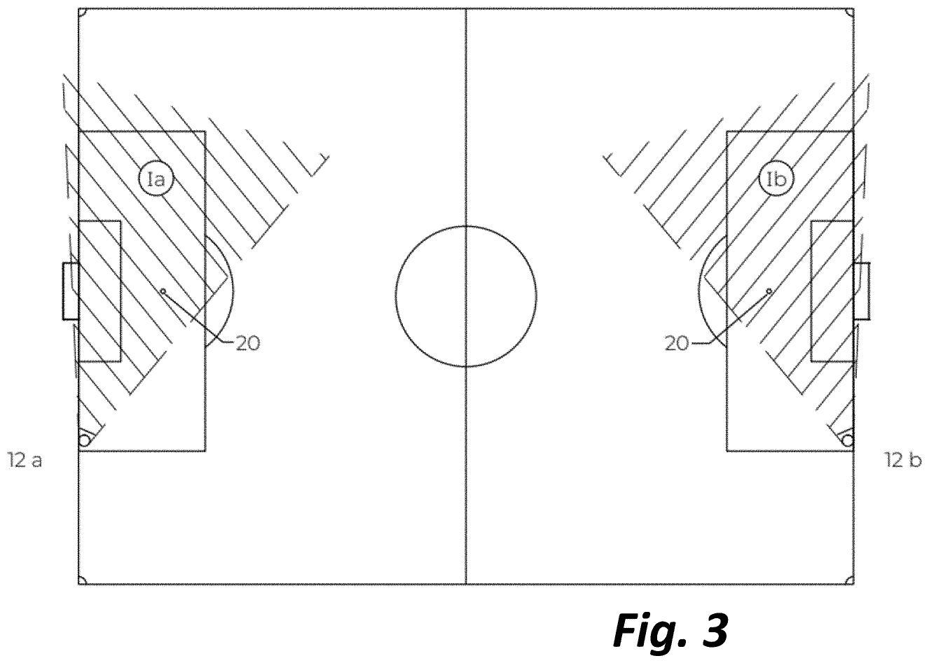

FIG. 3 shows both Video Detection Cameras 12a and 12b, and their corresponding Video Detection Areas Ia and Ib. The video filmed by these cameras is processed by the Computer 22 to detect whether a ball is inside an area that triggers the system to create a highlight video clip. To improve the quality of the detection, cameras are located close to areas where goals occur; thus, soccer balls are captured closer and with greater detail.

FIG. 4 shows a picture of a Video Capture Camera 14a or 14b which is located to have angle that shows the highlights with clarity. In this case, it is mounted on the side of a soccer field and provides a good perspective to appreciate a goal. The camera is attached to a fence surrounding a soccer field thus eliminating the need for a separate Camera Support 18. The location of these cameras can be adjusted to get different perspectives of a notable action, having the option to pick the best of them.

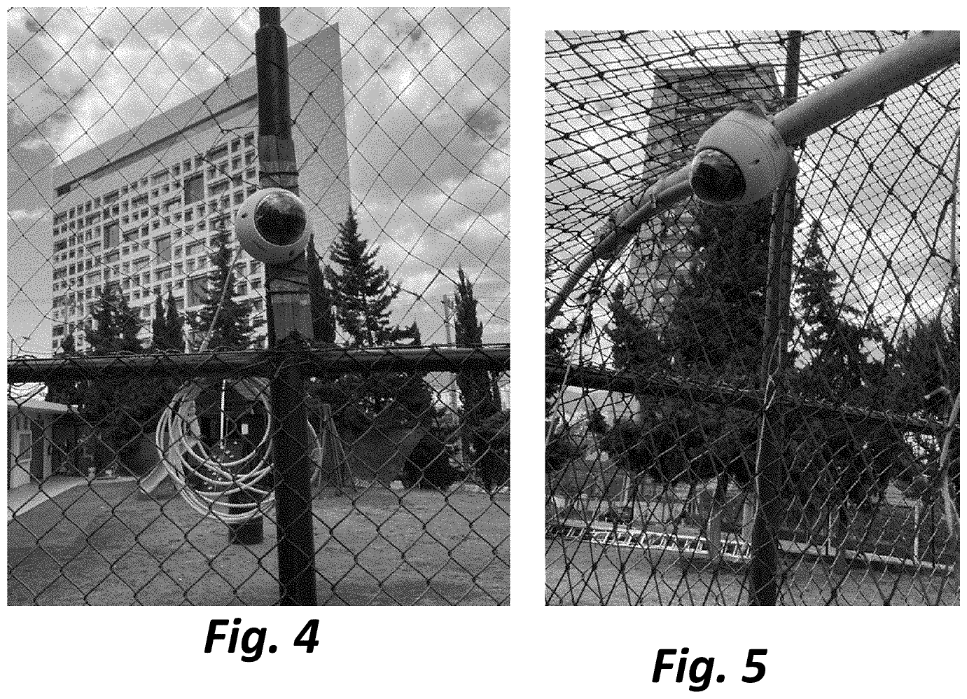

FIG. 5. displays a picture of a Video Detection Camera 12a or 12b from which videos are analyzed to determine if a ball is detected. This camera is located right behind the Goal 30 and without any objects, such as a net interfering its view. This position allows the camera to have a closer view of the approaching objects, whose videos are sent to the processor (i.e., the Computer 22) where an artificial intelligence algorithm is run to measure the probability of each object being a ball.

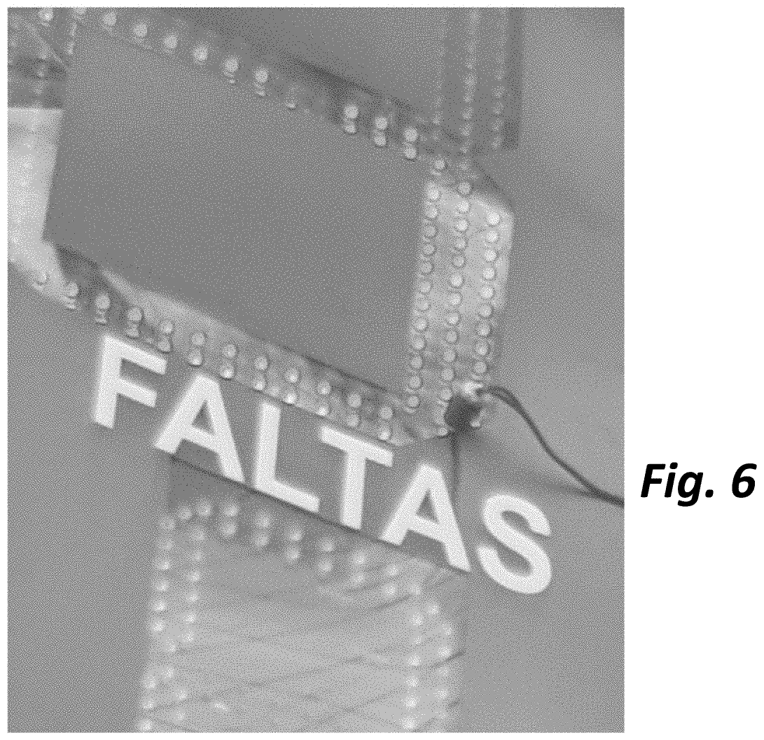

FIG. 6 shows a photo of a Sensor 16 on a Scoreboard 10. The sensor sends a signal to a processor in which it is determined whether time is running on the Scoreboard 10. In this case, a light detection sensor is used, but other types of sensors (or using artificial intelligence with a camera) may be employed to “read” the numbers and see whether time is running. The main use for this sensor is to detect whether a game is taking place. If time is running, it is assumed that the game is going on. This element differentiates goals that occur in actual games from ones that take place in warmup or during half time. This is useful, for players prefer to watch goals from actual games to those that occur during warmup or half time.

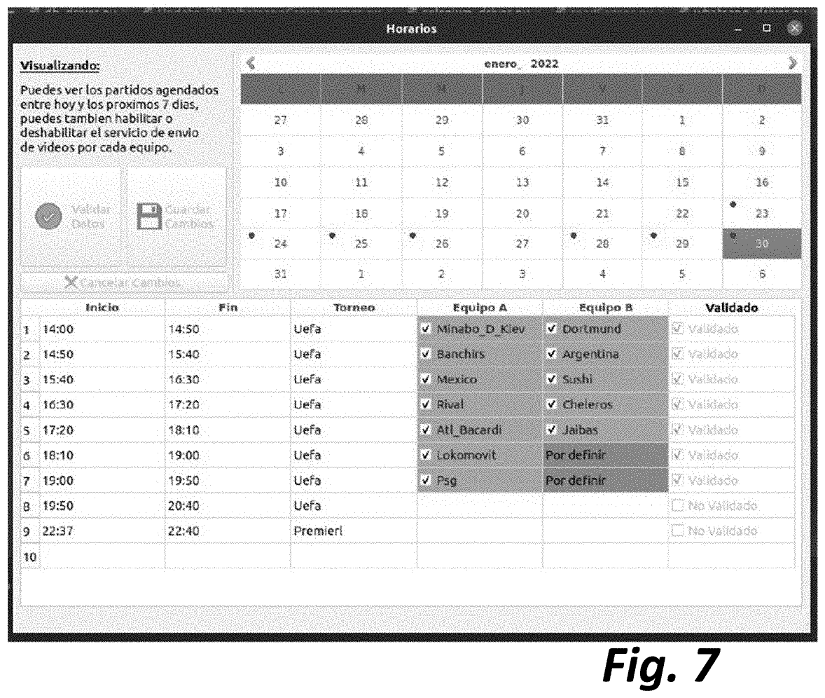

FIG. 7 presents a screenshot of a day's match schedule store in Computer 22 and displayed on Computer 22's monitor. It is from here that the software gets names of teams to which the video clips will be sent. The program retrieves contacts of players of a team from the database and sends them using an electronic platform such as WhatsApp, Telegram, email, SMS or any other similar communications utility.

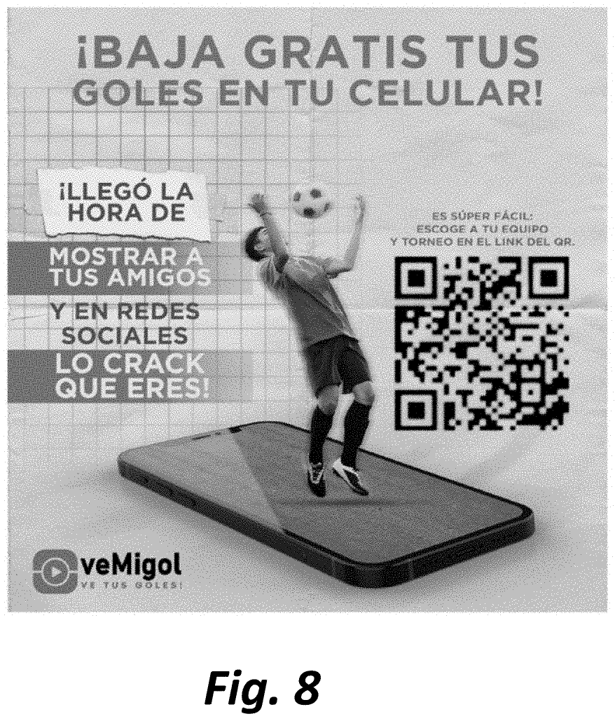

FIG. 8 shows a display panel with a QR code to be scanned with a mobile phone, which provides an alternate way for players and interested people to receive their goals. It is more efficient, as it bypasses players or venue operators having to register team players' contact on a database. In one embodiment, a QR code is outside a soccer field and when scanned, it sends all goals scored during a specified time that just occurred to the mobile device that scanned the QR code, for example 90 minutes. This time is the regular duration of a match. On an alternative embodiment, the QR can send goals of the preceding match or training, as specified on a schedule of matches for a day.

This element helps reduce steps for users in another way, as the system can detect when a particular mobile has scanned the QR code to receive goals of a team two occasions. The system can start sending the goals from the third time onwards, without there having the need to scan the code.

An alternative embodiment would be for the QR to direct towards an application where the user can select his or her tournament's name and the team's name from pull down menus. Then they always can receive goals from that team, whenever it plays. The application also allows users to provide additional identification and contact information for the user and people related to the user such as family members, friends, coaches, or the like. When such information is provided and stored in the system's identification and delivery database, video clips created by the system from video streams from the Video Capture Cameras 14a and 14b stored in the system's video capture database may be sent not only to the player but also to the people identified by the player as related to the player.

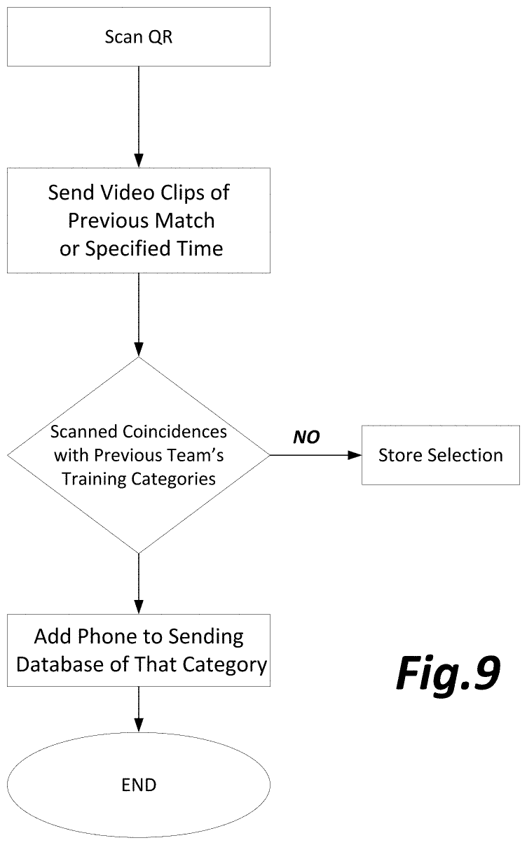

FIG. 9 is a flow chart of Fast QR Team Signup showing how a QR code can be used to optimize the process of signing up to receive a particular team's highlights. Other types of codes, such as a bar code or alpha-numeric code, may be used without deviating from the invention. If a person scans the QR code, that phone will receive the previous event's important moments, that is the system will send all video clips from the previous game or training. Then the system checks for coincidences between the teams that just played and any other QR codes that phone has scanned before. If there are coincidences, the phone will automatically receive highlights of the team which coincided.

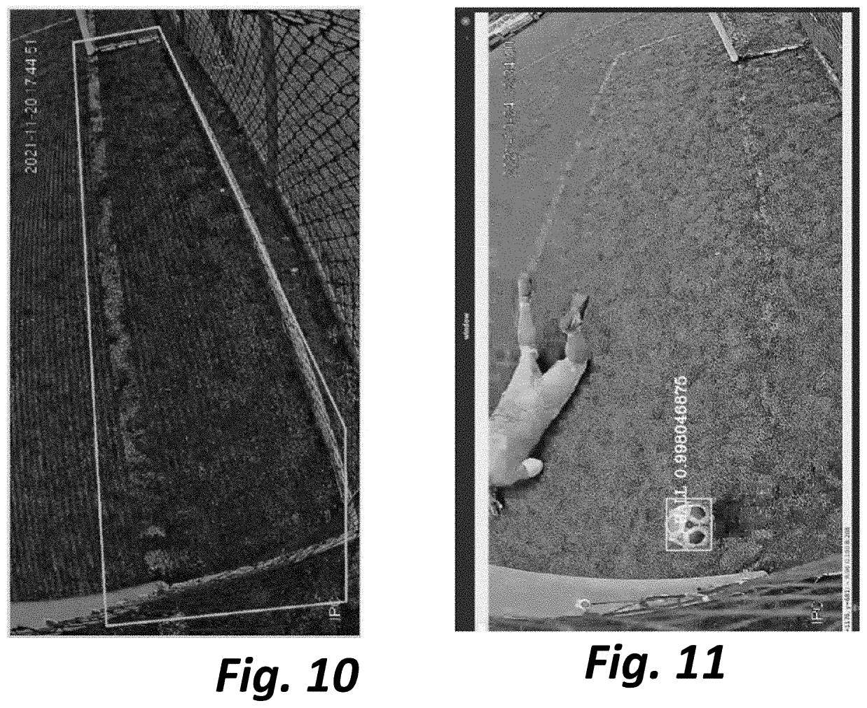

FIG. 10 shows a screenshot where a Virtual Polygon 32 limits the area where a ball will be detected. If the algorithm determines that a ball has been detected over a certain threshold in that area, it makes the assertion that a goal has been scored. The Virtual Polygon 32 is set close to the Goal 30 in this screenshot but can be set elsewhere to trigger highlights on other parts of the soccer field, such as Penalty Kick 20 or Corner Kick 21.

FIG. 11 presents a screenshot of a ball detection training by artificial intelligence. It has a percentage representing the certainty with which the system detects a ball. This is done, by training an algorithm with large amounts of pictures of real-life examples, and having it only detect soccer balls and no other elements. The systems then the probability above a certain threshold as a trigger for creating a video clip from video stream created using Video Capture Camera 14a and/or 14b.

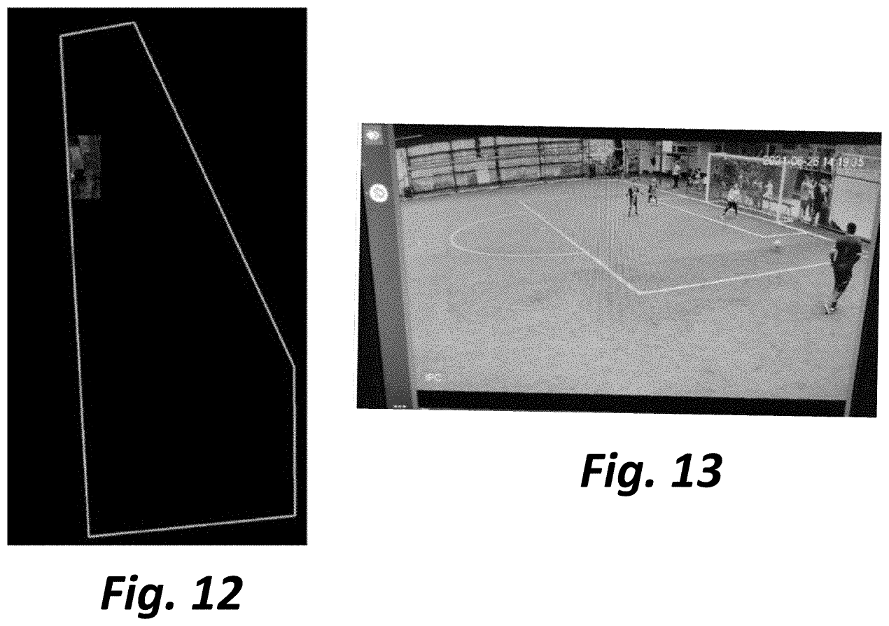

FIG. 12 is a screenshot of the system detecting movement in Virtual Polygon 32. Calculations take place only when and where movement is detected. In this image, all the dark area represents the places where no movement is detected and the colored square on the top right where movement was detected. In this case, a ball entered the Virtual Polygon 32 on the top right, and color shows up. That ball detection triggers the system to find the segment of the video, cut it, and sending it to users.

FIG. 13 is a screenshot of players in a processor's monitor, i.e., the monitor of Computer 22. The processor may be on site or in the cloud and the processor (Computer 22) identifies, creates and transmits the highlight video clips are sent to users.

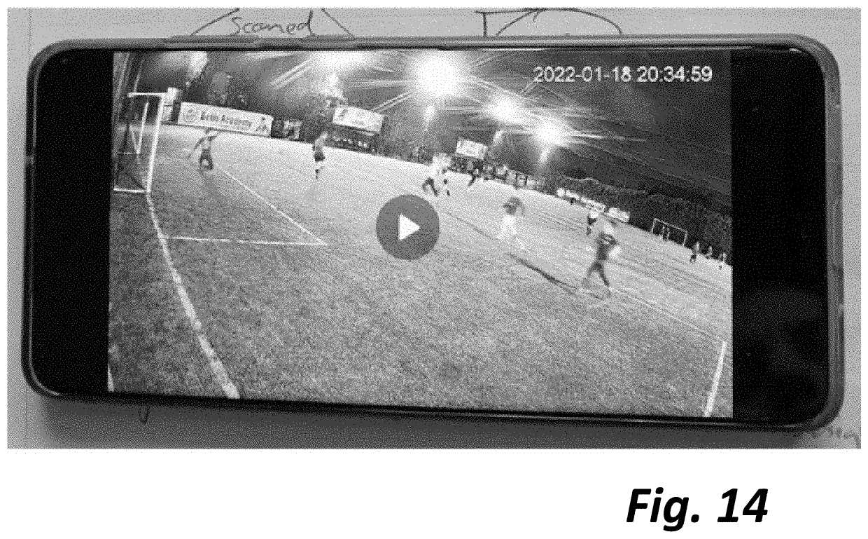

FIG. 14 shows how a highlight video clip of a goal transmitted by the Computer 22 that may be viewed on a mobile phone by a user. Such video clip my be transmitted by the Computer 22 to the mobile phone using any of a variety of social communication platforms.

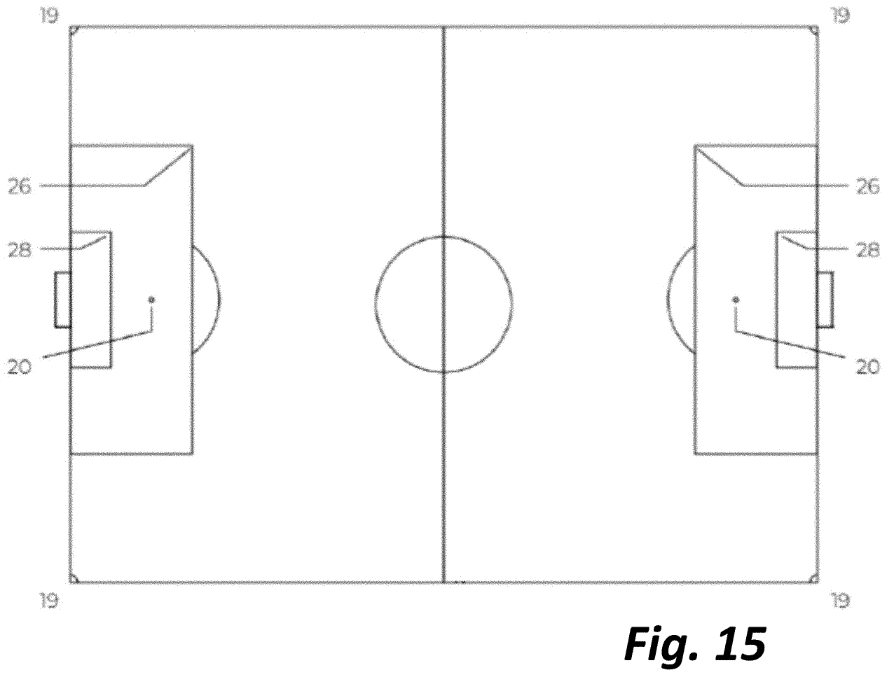

FIG. 15 depicts elements within a soccer field where a play in or on them can generate the creation of a highlight video clip. These elements are two Penalty Spots 20, two Penalty Boxes 26, four Corner Arcs 19, and two Goal Boxes 28. The system can be set so that when a ball kick is detected in those areas, the retrieval, trimming and sending of highlight video clips is activated. Typically, the trimmed portion of the video stream used to create the highlight video that has a duration beginning a predetermined time before the detected event and ending a predetermined time after the detected event.

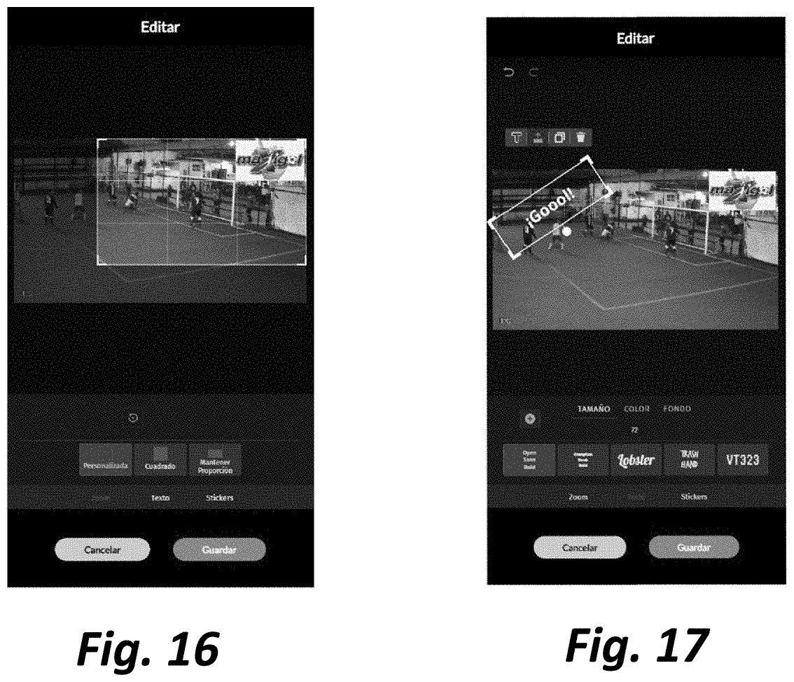

FIG. 16 displays a screenshot of an accompanying app that allows users to zoom into an area within the monitor where they want the video clip to focus. That video may then be trimmed to only focus on that area.

FIG. 17 shows a screenshot of a highlight video clip to which text has been added.

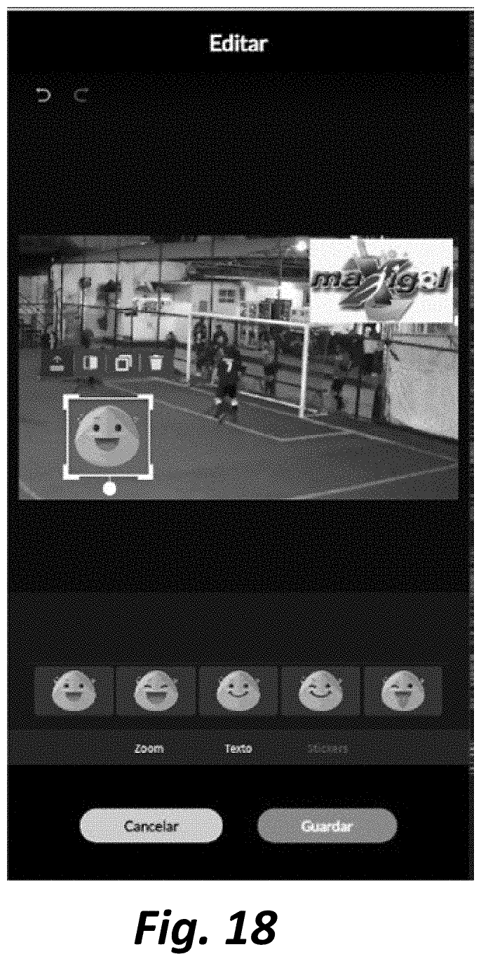

FIG. 18 shows a screenshot of a virtual graphic image superimposed on top of a video clip. Many different types of those images may be used when creating the clip, as well as sound in different forms.

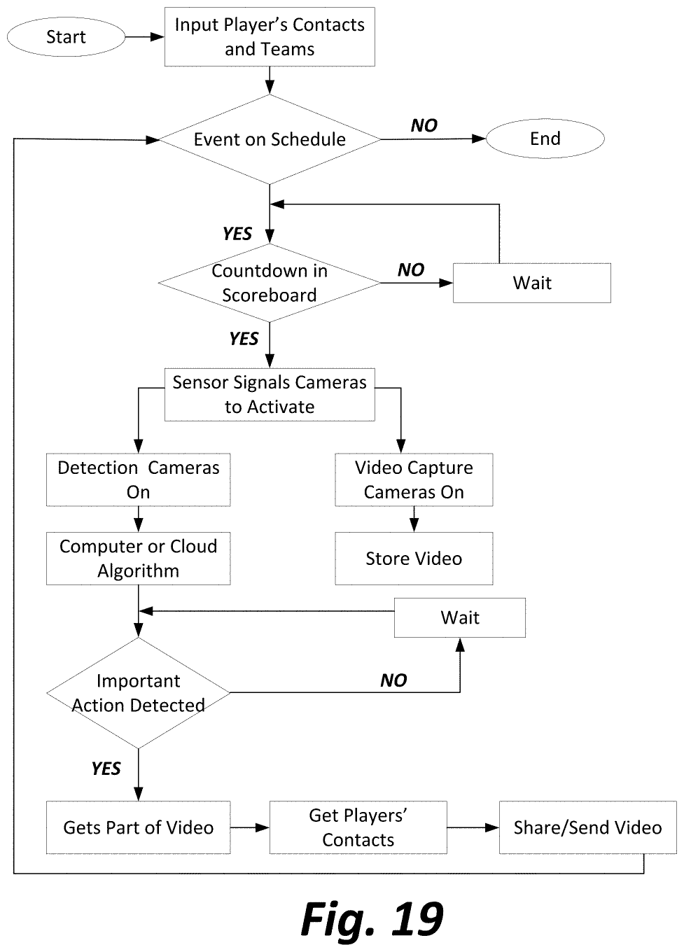

FIG. 19 is a flowchart showing how the system operates. First, player and team data are input into an identification and delivery database either by entering them directly onto a database using the systems user interface, or by a smart phone controlled by a user. When a smart phone is used, the user scans a QR code with the phones, selects tournament and team, and is provided with the option to add additional identification and delivery information and preferences.

When an event is on schedule and the countdown on the Scoreboard 10 has started, all the cameras are activated. The Video Capture Cameras 14a and 14b send the video of the whole game to be temporarily stored in video capture database managed by Computer 22. This database may be stored on Computer 22 or in the cloud.

The Detection Cameras 12a and 12b are on as well and send their own video to a Computer 22 or Cloud. Computer 22 runs an algorithm analyzing the video feeds from Detection Cameras 12a and 12b. Whenever Computer 22 detects an important event such as a ball inside Virtual Polygon 32, Computer 22 sends a signal with the appropriate time and instructions to create a highlight clip by trimming or copying that portion of the video stream beginning some predetermined number of seconds before the detection and ending some predetermined number of seconds afterward the detection. The system then retrieves the players' contacts from the identification and delivery database and transmits the highlight video clip based on such the delivery information linked to the player in the identification and delivery database. For example, if the player is associated with a smart phone's telephone number (address) the Computer 22 links to that smart phone's number and send the highlight video clip to the smart phone.

The system goes back to check if a match is still scheduled (including a tolerance in case one runs late). If there are no matches on schedule, the system stops.

Video is also available for users in a digital application. The players or any authorized person can edit with option such as zoom, put text, insert sound, or superimpose a virtual image on the video. This edited video can be viewed and sent.

Various modifications may be made without deviating from the invention. For description purposes, this system was portrayed for use in connection with s soccer venue and a soccer sporting event. The system may also be employed and performs just as well in conjunction with other sports such as basketball, hockey, lacrosse, water polo, among others. Some elements, such as places that trigger highlights are adjusted, but the general function remains the same. For example, in hockey, a Virtual Polygon Area can be set in the goal or on the goal crease to detect a puck, an artificial intelligence trained to detect it, and the system to trim and send the video to players set.

While multiple cameras are depicted in the Figures, just one camera can be used. This video captured would be used for both elements, that is detection of goals and trimming of the video to be sent. Alternatively, more cameras could be used. If more Video Capture cameras are used, then the system could film videos from different angles or at different close-up levels. Multiple video clips could then come from a single event.

Other game elements could trigger the system to create highlight video clips. For example, a camera detecting Corner Arc 19, would trigger whenever there is a corner kick, same for Penalty Kick 20. Likewise, particular types of passes, types of shots, faults, when the ball travels over a determined speed (going very fast in the goal direction), different types of moves, or other elements and trigger the creation of a highlight video clip.

Video highlight clips could be sent or shared through different ways, for example email, WhatsApp, Telegram, SMS, or an application. If another communication platform becomes popular in the future, that platform could be used as well.

Different types of animation could be added to the highlight video clips. Such animation could include augmented reality, virtual reality, or other animation elements.

The system can be modified to control distribution of the highlight video clips. For example, the systems could send the video highlights to one player, to the whole team, to both teams playing in a game, or to a wider audience.

The system can employ face recognition or some other type of identification method to determine which player was the one that performed the highlight.

The system could register, keep track of, and include within the highlight video clip test and graphs related to such highlights, such as height of a jump, speed of a ball, number of times he shot, or other.

Advanced cameras with built in processors and communication elements replacing Computer 22 could be employed such that all functions related to the detection of highlights and the creation and transmission of highlight video clips are performed in camera.

The system has been described as using detection cameras generating a video feed processed by the Computer 22 to detect a highlight, the detection cameras could be replaced with other technologies without deviating from the invention. Such technologies may employ radar, sonar, laser, or other transducers in place to the detection cameras.

Within the scope of the following claims, the invention may be practiced otherwise than as specifically shown in the drawings and described above. The foregoing description is intended to explain the various features and advantages but is not intended to be limiting. The scope of the invention is defined by the following claims which are also intended to cover a reasonable range of equivalents.

What is claimed is:

1. An apparatus for creating and transmitting highlight videos related to an event comprising a processor coupled to at least one highlight detection sensor, at least one video capture camera, a first database adapted to contain identification and related delivery information, a second database adapted to contain video streams captured by said at least one video capture camera, and a play sensor adapted to transmit signals indicative of the actual beginning of an event, wherein said processor is adapted to receive a signal indicative of the actual beginning of an event from said play sensor and to respond to that signal indicative of the actual beginning of an event by (i) actuating said at least one video capture camera and storing in said second database at least one video stream transmitted by said at least one video capture camera, (ii) actuating said at least one highlight detection sensor and monitoring said highlight detection sensor for changes indicative of a highlight, (iii) creating a video clip comprising a selected portion of said at least one video stream in response to changes indicative of a highlight, and (iv) transmitting the video clip based on identification and delivery information contained in the first database.

2. The apparatus for creating and transmitting highlight videos related to an event of claim 1 further comprising a scanner adapted to scan codes containing identification and delivery information and populate the first database with identification and delivery information contained in said scanned codes.

3. The apparatus for creating and transmitting highlight videos related to an event of claim 1 wherein said identification information includes information identifying a player and said player's team.

4. The apparatus of claim 3 wherein said related delivery information includes an electronic address related to the player.

5. The apparatus for creating and transmitting highlight videos related to an event of claim 1 wherein said play sensor adapted to transmit signals indicative of the actual beginning of an event is couple to a scoreboard located at a venue where the event is taking place.

6. The apparatus for creating and transmitting highlight videos related to an event of claim 1 wherein said play sensor adapted to transmit signals indicative of the actual beginning of an event is a camera pointed toward and focused on a clock on a scoreboard located at a venue where the event is taking place.

7. The apparatus for creating and transmitting highlight videos related to an event of claim 1 wherein said at least one highlight detection sensor is at least one highlight detection camera adapted to transmit a video feed to the processor and focused on a portion of a playing surface where highlights often occur.

8. The apparatus for creating and transmitting highlight videos related to an event of claim 1 wherein said at least one highlight detection sensor comprises a plurality of highlight detection cameras adapted to transmit video feeds to the processor and focused on multiple portions of a playing surface where highlights often occur, and wherein said controller is adapted to actuate each of said plurality of highlight detection cameras and monitor the video feeds from each of said highlight detection cameras for changes in any of said video feeds indicative of a highlight.

9. The apparatus for creating and transmitting highlight videos related to an event of claim 8 wherein said at least one video capture camera comprises a plurality of video capture cameras pointed toward and focused on multiple portions of a playing surface, and wherein said controller is adapted to actuate each of said plurality of video capture cameras and store in said second database separate video streams generated by each of said plurality of video capture cameras.

10. The apparatus for creating and transmitting highlight videos related to an event of claim 9 wherein said controller is adapted to determine which of said plurality highlight detection cameras generated a video feed containing changes indicative of a highlight, select at least one video stream from the separate video streams generated by each of said plurality of video capture cameras based on said determination, create from said selected at least one separate video stream a video clip, and transmit said video clip based on identification and delivery information contained in the first database.

11. The apparatus for creating and transmitting highlight videos related to an event of claim 9 wherein the controller is adapted to select a plurality of said video streams, create from said selected video streams a composite video clip, and transmit said composite video clip based on identification and delivery information contained in the first database.

12. The apparatus for creating and transmitting highlight videos related to an event of claim 1 wherein selected portion of said at least one video stream is of a predetermined duration, said duration commencing a first predetermined period of time before and ending a second predetermined period of time after a change is detected indicative of a highlight.

13. The apparatus for creating and transmitting highlight videos related to an event of claim 11 wherein said composite video clip is of a predetermined duration, said duration commencing a first predetermined period of time before and ending a second predetermined period of time after a change in a video feed indicative of a highlight.

14. An apparatus for creating and transmitting highlight videos related to an event comprising a processor coupled to a plurality of highlight detection camera each pointed toward and focused on a separate portion of a playing venue, at a plurality of video capture cameras each pointed toward and focused on a separate portion of a playing venue, a first database adapted to contain identification and related delivery information, a second database adapted to contain separate video streams captured by said plurality of video capture cameras, and a sensor adapted to transmit signals indicative of the actual beginning of an event, wherein said processor is adapted to receive a signal indicative of the actual beginning of an event from said sensor and to respond to that signal indicative of the actual beginning of an event by (i) actuating said plurality of video capture cameras and storing in said second database a separate video stream transmitted by each of said plurality of video capture cameras, (ii) actuating said plurality of highlight detection camera, monitoring separate video feeds generated by said highlight detection cameras, and identifying a change in any of said separate video feeds indicative of a highlight, (iii) selecting at least one of said plurality of video streams in response to changes in the video feed indicative of a highlight, (iv) creating a video clip from said selected at least one of said plurality of video streams, and (v) transmitting the video clip based on identification and delivery information contained in the first database.

15. The apparatus for creating and transmitting highlight videos related to an event of claim 14 wherein said video clip is of a predetermined duration, said duration commencing a first predetermined period of time before and ending a second predetermined period of time after the identified change indicative of a highlight.

16. The apparatus for creating and transmitting highlight videos related to an event of claim 14 wherein said video clip is a composite video clip created from at least two of the video streams transmitted by said plurality of video capture cameras.

17. The apparatus for creating and transmitting highlight videos related to an event of claim 14 wherein said sensor adapted to transmit signals indicative of the actual beginning of an event is coupled to a clock on a scoreboard at the playing venue.

18. The apparatus for creating and transmitting highlight videos related to an event of claim 14 wherein said sensor adapted to transmit signals indicative of the actual beginning of an event is a video camera pointed toward and focused on a clock of a scoreboard at the playing venue.

19. A method for creating and transmitting highlight videos related to an event comprising:
(a) installing at a venue an equipment array comprising at least one highlight detection camera, at least one video capture camera, and a sensor adapted to transmit signals indicative of the actual beginning of an event,
(b) creating a two-way communication link between said equipment array and a controller having access to a first database adapted to contain identification and related delivery information, a second database adapted to contain separate video streams captured by said plurality of video capture cameras,
(c) using the controller, upon receipt by the controller of a signal from the sensor indicative of the actual beginning of an event, to (i) actuate each of said at least one video capture cameras, (ii) receive from each of said at least one video capture cameras a separate video stream, (iii) store each separate video stream in the second database, (iv) actuate each of said at least one highlight detection cameras, (v) receive from each of said at least one highlight detection cameras a separate video feed, (vi) monitoring each such separate video feed received from said at least one highlight detection cameras for changes in the video feed indicative of a highlight, (vii) whenever a change in the video feed indicative of a highlight is detected, creating a video clip comprising a selected portion of said at least one video stream, and (viii) transmitting the video clip based on identification and delivery information contained in the first database.

20. The method for creating and transmitting highlight videos related to an event of claim 19 wherein said selected portion of said at least one video stream is of a predetermined duration, said duration commencing a first predetermined period of time before and ending a second predetermined period of time after a change in a video feed indicative of a highlight.
